(19) United States
(12) Patent Application Publication
(10) Pub. No.: US 2007/0003771 A1
(43) Pub. Date: Jan. 4, 2007

(54) Grip wax of skis, a method for waxing skis and a product for waxing skis

(76) Inventor: Jukka Jarvinen, HOLLOLA (FI)

Correspondence Address: YOUNG & THOMPSON, 745 SOUTH 23RD STREET, 2ND FLOOR, ARLINGTON, VA, 22202, US

(21) Appl. No.: 10/543,146

(22) PCT Filed: Jan. 26, 2004
(86) PCT No.: PCT/FI04/00036

§ 371 Date: May 3, 2006

(30) Foreign Application Priority Data
Jan. 24, 2003 (FI) 20030114

(51) Int. Cl. B32B 27/32; B32B 27/10

(52) U.S. Cl. 428/447; 428/452; 428/521; 428/537.5

(57) ABSTRACT

The invention relates to a grip wax of skis containing polyisobutylene base, resin as grip material and wax as glide material. Furthermore, the invention relates to a corresponding method and product for applying grip wax os skis to the ski bases. In the method, the grip wax is melted to form a uniform film over a transfer substrate; a strip of desired length and having the width of the ski is prepared of the transfer substrate; the strip is pressed with the wax surface facing downwards against the ski base and is pressed in place in ambient temperature without external heating, and the transfer substrate is withdrawn from top of the wax film that stuck to the ski baes, and the waxing is completed.

The invention relates to a grip wax of skis, a method for applying grip wax to skis as well as a product for applying grip wax to skis.

Conventionally, grip waxes of skis must be carefully selected according to prevailing temperatures; pastes for damp conditions and harder and more durable waxes for cold temperatures. In case the temperature is too high compared to the grip wax to be used, there will not be enough grip. In case the temperature is, in turn, too low, the grip wax will ice and will not provide glide. Due to this, under the present varying weather conditions the waxing is constant changing and experimentation of new waxes.

In addition, the new waxes require relatively much work, rubbing, application, smoothing, pasting, removal of waxes, etc. Cloths, gloves and hands often get sticky. In addition, the car, ski box or some other means of transportation often are fouled by skis that have been waxed already at home.

Another problem with the present waxes is their weak wear resistance. If you are on a ski trail a little longer, you must have grip waxes and preferably many sorts of them as the temperature may change even very fast, particularly when skiing in mountain conditions.

There has been an attempt to try to eliminate part of these problems by a means in accordance with publication WO 80/01355 in which the grip wax is applied to the ski bases as an adhesive strip. The publication discloses, however, just the idea and not an implementable solution because substantial in the waxes is their composition enabling the elimination of the aforementioned problems.

The objective of the invention is to eliminate the drawbacks referred to above. One specific objective of the invention is to disclose a new type of grip wax of skis, a new method for applying the grip wax as well as a new product for applying grip wax to the skis, these being easy, fast and simple to use, and furthermore applicable to a wide temperature range.

As for the features characteristic of the invention, reference is made to them in the claims.

The grip wax of skis in accordance with the invention comprises a high-molecular-weight polyisobutylene base, rosin alcohol or various modifications thereof as grip material and wax as glide material. According to the invention, there is more than 50% of high-molecular-weight base in the grip wax.

In one embodiment of the invention, the grip wax comprises more than 55, e.g. approximately 60% high-molecular-weight polyisobutylene base. It is even possible that there is 70-90% of that. Previously, polyisobutylene has been only used in small amounts in ski waxes as its importance has not been acknowledged, and above all as it has not been possible to apply it evenly and efficiently to the ski bases. The dominant portion of the polyisobutylene guarantees that the rip wax maintains a certain elasticity and, in addition to that, grip and durability when skiing in a wide temperature range. By scrubbing it directly to the ski bases it does not adhere sufficiently, and its melting requires a temperature so high that the ski bases would be damaged when applying the wax when molten. Now with the invention one has found optimal mixture ratios, considering both the glide and grip properties while at the same time inventing a method and means that enable the application of the wax.

In one embodiment of the invention, one uses in the high-molecular-weight polyisobutylene base an addition of a toughening binding agent, of which there is less than 6%, preferably less than 3%, in the base. As the binding agent it is possible to use e.g. LD polyethylene. The binding agent makes even a thin wax film a tough and compact one, whereby the film-like wax remains solid both when applying to the ski bases and when in use.

Resin is used in the grip wax as grip material, and there is 5-40, preferably 10-30, e.g. 15-25% of resin in the wax. A suitable rosin alcohol or various modifications thereof, such as e.g. hydroabiethyl alcohol, are used as resin.

Wax is used in the grip wax as glide material, and there is 5-40, preferably 10-30, e.g. 15-25% of wax in the wax. As the wax it is possible to use paraffin, but particularly advantageously as the wax, beeswax is used. A suitable amount of wax guarantees that the grip wax maintains its glide properties.

In one embodiment of the invention, 2-5% pit tar is used in the grip wax. It has been found to prevent the wax from icing. Furthermore, it provides the wax with colour and pleasant odour.

The invention also relates to a method for applying grip wax of skis to ski bases as described above. In the method, the grip wax is melted to form a thin, uniform film onto a suitable transfer substrate. The necessary temperature depends on the composition of the wax to be used, but it is in any case more than 100, e.g. 120-150° C. As the transfer substrate it is possible to use a paper or plastic-based, e.g. a silicone treated substrate, to which the film does not adhere too much. After this, a strip of desired length and having the width or half of the width of the ski is prepared of the transfer substrate. These steps are performed industrially and advantageously in a large scale. When the skier wishes to wax his or her skis, he or she presses the strip with the wax surface facing downwards against the ski base and presses it in place in ambient temperature without external heating, e.g. just by slightly pressing with his or her palm. Finally, the transfer substrate is withdrawn from top of the wax film that stuck to the ski bases, and the waxing is completed.

Thus, substantial in the waxing method of skis in accordance with the invention is that in the actual waxing of skis, no external heating is needed, and no abrasive, smoothing or stroking working phases are needed, instead due to the correct composition, the wax film adheres well to ski bases, remaining solid and undamaged. In this manner it forms a finished and durable layer of grip wax. The necessary uses of temperature and the smooth formations of the wax film are performed industrially in a controlled manner.

Advantageously, as the ambient temperature, a suitable inside temperature in the range 15-25° C. is used, whereby a good adhesion of the wax film to the ski bases is guaranteed, when as the wax film, one of the aforementioned grip waxes in accordance with the invention is used.

Furthermore, the invention relates to a product for applying grip wax to skis. The product in accordance with the invention consists of a silicone treated paper strip and a film of grip wax melted at the other end of the paper strip, the film of grip wax being one of the aforementioned grip waxes in accordance with the invention. The thickness of the film of grip wax being used can range between 0.01-1 mm.

In the product in accordance with the invention, the silicone treated paper strip and the film of grip wax on the surface thereof may be rolled-up, whereby its handling and keeping e.g. in the pocket when skiing is easy. On the other hand, the product can also be a straight strip so that the film of grip wax is disposed between two silicone treated paper strips. In that case, the lengths of the strips must be appropriate ones, whereas from a roll it is possible to cut-strips of grip wax of the length each time suitable.

The grip wax, waxing method and product in accordance with the invention have considerable advantages compared to prior art. The grip wax functions in a wide temperature range without icing while at the same time maintaining its glide and grip properties.

The durability of the grip wax is outstanding, i.e. a ski once treated withstands normal skiing several hundreds of kilometres. Even on such a long ski tour there is no need to re-wax the skis. The waxing is a very simple and easy procedure in which no instruments, additional heat, rubbing, applying etc. are needed. As the product adheres better in the inside temperatures, the grip wax can be applied already at home when going skiing, and the paper can be left in place, whereby the transportation e.g. in a car is tidy. When going on a ski trail, the papers are just stripped off and the skis are ready. In this way, the wax remains clean and tidy, during the transportation without dirtying the car.

### EXAMPLE

In the tests carried out, the grip wax was found to function very well with the following mixture ratios:

55-65% high-molecular-weight polyisobutylene

1-3% LD polyethylene

15-25% hydroabiethyl alcohol

15-25% beeswax.

As an example we mention a grip wax having about

58% high-molecular-weight polyisobutylene

2% LD polyethylene

20% hydroabiethyl alcohol

20% beeswax.

The grip wax presented above was melted and, applied as a thin layer over the surface of a silicone treated paper, from which it was moved to the ski bases in room temperature.

One skied these skis more than 200 km with the temperature ranging from +4° C. damp weather to −15° C. cold weather. The wear resistance of the wax is outstanding. The action of the ski wax has been outstanding in all conditions. Both grip and glide have been good and changeless during the whole test. After the test, the grip wax showed no considerable signs of abrasion.

1. A grip wax of skis comprising a high-molecular-weight polyisobutylene base, rosin alcohol or various modifications thereof as grip material, and wax as glide material, characterised in that the grip wax contains more than 50% high-molecular-weight polyisobutylene base.

2. The grip wax of skis as defined in claim 1, characterised in that the grip wax contains more than 55, e.g. about 60% high-molecular-weight polyisobutylene base.

3. The grip wax of skis as defined in claim 1, characterised in that preferably the polyisobutylene base contains less than 6%, preferably less than 3% toughening binding agent.

4. The grip wax of skis as defined in claim 3, characterised in that as the toughening agent, LD polyethylene is used.

5. The grip wax of skis as defined in claim 1, characterised in that as the rosin alcohol, hydroabiethyl alcohol is used.

6. The grip wax of skis as defined in claim 1, characterised in that there is rosin alcohol 5-40, preferably 10-30, e.g. 15-25%.

7. The grip wax of skis as defined in claim 1, characterised in that as the wax, paraffin is used.

8. The grip wax of skis as defined in claim 1, characterised in that as the wax, beeswax is used.

9. The grip wax of skis as defined in claim 1, characterised in that there is wax 5-40, preferably 10-30, e.g. 15-25%.

10. A method for applying grip wax of skis to ski bases by using a grip wax as defined in claim 1, characterised in that
the grip wax is melted to form a thin, uniform film onto a transfer substrate,
a strip of desired length and having the width of the ski is prepared of the transfer substrate,
the strip is pressed with the wax surface facing downwards against the ski base and is pressed in place in ambient temperature without external heating, and
the transfer substrate is withdrawn from top of the wax film that stuck to the ski bases, and the waxing is completed.

11. A product for applying grip wax to skis, characterised in that the product consists of a silicone treated paper strip and a film of grip wax as defined in claim 1, which is melted at the other end of the paper strip.

12. The product as defined in claim 11, characterised in that the thickness of the film of grip wax is 0.01-1 mm.

13. The product as defined in claim 11, characterised in that the paper strip and the film of grip wax on the surface thereof are rolled-up.

14. The product as defined in claim 11, characterised in that the product is a straight strip so that the film of grip wax is disposed between two paper strips.
